(19) United States
(12) Patent Application Publication
(10) Pub. No.: US 2022/0318666 A1
(43) Pub. Date: Oct. 6, 2022

(54) TRAINING AND SCORING FOR LARGE NUMBER OF PERFORMANCE MODELS

(71) Applicant: International Business Machines Corporation, Armonk, NY (US)

(72) Inventors: Tong Luo, Wuhan (CN); Yi Dai, Beijing (CN); Guang Ming Zhang, Beijing (CN); Bing Jiang Sun, Beijing (CN); Shun Xin Cao, Hefei (CN); Yan Chen, Beijing (CN); Ling Zhuo, Beijing (CN)

(21) Appl. No.: 17/218,035

(22) Filed: Mar. 30, 2021

(51) Int. Cl. G06N 20/00; G05B 23/02

(52) U.S. Cl. CPC G06N 20/00; G05B 23/0243

(57) ABSTRACT

A method is presented to facilitate the training of a very large number of machine-learning performance models used to detect anomalies in computing operations. The models are grouped together according to model type, and are allocated to different pods of a computing environment that is used to carry out the operations being monitored. Initial training of models in a group is carried out while monitoring resource usage, and a particular pod is selected for further training based on the resource usage. The pod selected for training preferably has a minimum change in resource usage before and after the initial training. A different pod can be selected for scoring the trained models. The pod selected for scoring preferably has a maximum resource usage during an initial scoring among all pods.

### BACKGROUND OF THE INVENTION

### Field of the Invention

The present invention generally relates to computer systems, and more particularly to a method of training performance models to detect operational anomalies.

### Description of the Related Art

As computing operations become more complicated and the underlying infrastructures becomes less centralized, such as in cloud computing, it is increasingly important to be able to monitor such operations to optimize system performance. Many approaches have been devised to automatically detect potential anomalies in the functioning of large computing systems that might be indicative of serious operational problems. Some of these approaches use various models for the system that are based on temporal key performance indicators.

This area is part of a larger technological field referred to as information technology (IT) operations analytics, which attempts to discover complex patterns in high volumes of often noisy performance data. These analytics can include artificial intelligence for IT operations, referred to as AIOPs, that rely on cognitive systems. A cognitive system (sometimes referred to as deep learning) is a form of artificial intelligence that uses machine learning and problem solving. Cognitive systems often utilize neural networks although alternative designs can be used, such as a support vector machine (SVM) or Bayesian networks. A modern implementation of artificial intelligence is the Watson™ cognitive technology marketed by International Business Machines Corp.

Models used in anomaly detection can employ such cognitive systems. The models attempt to capture the normal functioning of the computing operations. If the current operational state significantly deviates from the model then a possible anomaly has been detected, and an alert can be generated for a supervisor or other automated solution. Different model types can be used in anomaly detection such as simple statistical methods or challenges, or machine-learning based approaches such as density-based, clustering-based, SVM-based, Bayesian networks, as well as custom detection models. Each model must be appropriately trained according to its model type, i.e., given a training data set indicating normal behavior of the system. The training can be unsupervised, supervised, or semi-supervised.

### SUMMARY OF THE INVENTION

The present invention in at least one embodiment is generally directed to a computer-implemented method of training a monitoring system for detection of anomalies in computing operations by receiving details regarding performance models to be used in detecting the anomalies, forming a group of the performance models, selecting a particular one of the performance models in the group, training the particular performance model, and applying this training to remaining performance models in the group. In the illustrative implementation the performance models are trained using machine learning, and each of the performance models in the group has the same model type. The performance models can be embodied in respective computing containers of computing pods which provide shared storage, shared network resources and a shared context for all containers within a given computing pod, and a particular computing pod is selected for the training, the particular computing pod containing a training service that carries out the training. Selection of this computing pod can include determining that it has a minimum change in resource usage over a first period of time before initial training compared to a second period of time after initial training among all computing pods containing performance models in the group. The invention can further be implemented with additional scoring once performance models have been trained, by beginning initial scoring of trained performance models in certain computing pods, monitoring resource usages of those computing pods during the initial scoring, selecting a specific computing pod other than the computing pod used for training to continue scoring based on the resource usages, and completing scoring of a performance model using a scoring service contained in this specific computing pod. Selection of this computing pod can include determining that it has a maximum resource usage during the initial scoring among all pods carrying out the initial scoring.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a block diagram of a computer system programmed to carry out training of performance models used to detect operational anomalies in accordance with one implementation of the present invention;

FIG. 2 is a pictorial representation of a cloud computing environment in accordance with one implementation of the present invention;

FIG. 3 is a block diagram of a computing system having an application, in this example a database deployed via cloud computing, whose performance is to be modeled in accordance with one implementation of the present invention;

FIG. 4 is a block diagram of a computing pod of the computing system of FIG. 3 showing various models and training and scoring services in accordance with one implementation of the present invention;

FIG. 5 is a set of equations governing the selection of a particular computing pod for purposes of training models in accordance with one implementation of the present invention;

FIG. 6 is a chart illustrating the logical flow for a model training process in accordance with one implementation of the present invention; and

FIG. 7 is a chart illustrating the logical flow for a model scoring process in accordance with one implementation of the present invention.

The use of the same reference symbols in different drawings indicates similar or identical items.

### DESCRIPTION OF THE PREFERRED EMBODIMENT(S)

When monitoring computing operations in large-scale applications such as a cloud-deployed database, it is important to be able to detect any kind of operational anomaly for a lot of different metrics. A typical monitoring system will build a performance model for each metric to improve the accuracy of the anomaly detection. However, in large computing operations this can result in the need for hundreds of thousands, or even more than a million different models. For example, a database bank having 2,000 related databases and 100 metrics for each database would need 200,000 models to be able to find anomalies in real time for each metric. This presents a huge problem in creating the models because they have to be trained individually based on the different model types and relevant metric data. Training for a single anomaly detection model can be extensive, so training such a large number of models becomes prohibitive. Once trained, they also need to be scored which can additionally be computationally intensive at this scale.

It would, therefore, be desirable to devise an improved method of managing the creation and evaluation of very large numbers of performance models. It would be further advantageous if the method could allow training and scoring of very large numbers of models in a system with relatively limited resources. These and other advantages are achieved in various implementations of the present invention by training models based on the number and type of models and resource usage over time while regulating the computational infrastructure (pods) and available resources. Training can be balanced by distribution to different pods. Models can be grouped according to type, and a particular pod can be selected for training a group based on resource usage. Model scoring can also be based on the resource consumption of the model scoring after packing the model in different pods.

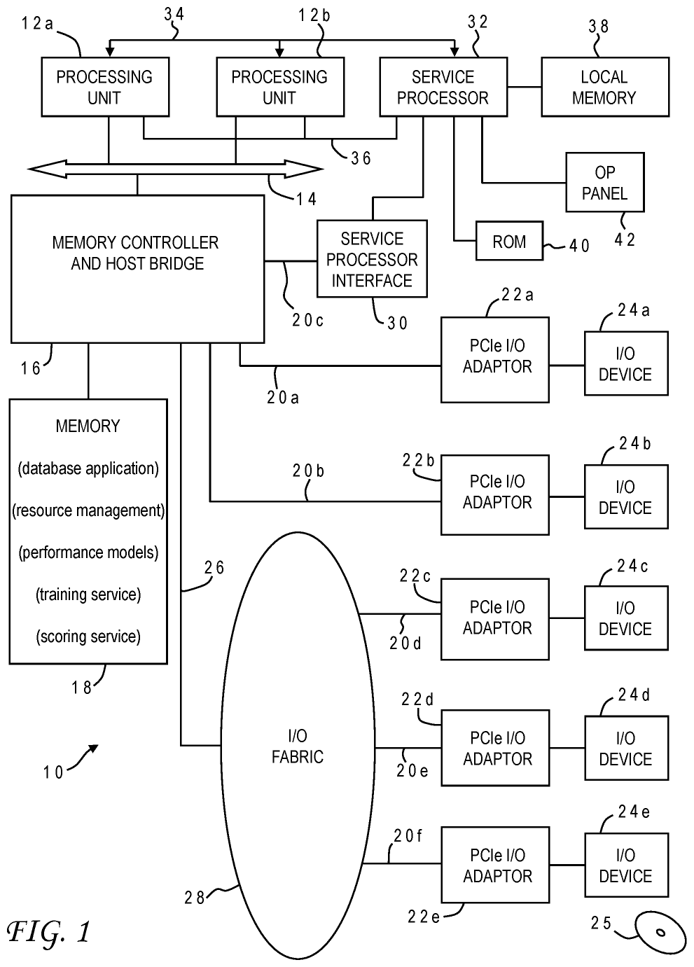

With reference now to the figures, and in particular with reference to FIG. 1, there is depicted one embodiment 10 of a computer system in which the present invention may be implemented to carry out the training of performance models for anomaly detection in large-scale computing operations. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches. System memory 18 has loaded therein one or more applications or program modules in accordance with the present invention. In an exemplary implementation, the applications include a database application with resource management tools, and the program modules include performance models along with training and scoring services.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f. These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive which receives an optical disk 25 (one example of a computer readable storage medium) such as a CD or DVD, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the model training and scoring programs of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

The present invention may be a system, a method, and/or a computer program product. The computer program product may include one or more computer readable storage media collectively having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 10 carries out program instructions for an operations monitoring process that uses novel computational techniques to manage the creation and evaluation of very large numbers of performance models. Accordingly, a program embodying the invention may additionally include conventional aspects of various performance modeling tools, and these details will become apparent to those skilled in the art upon reference to this disclosure. Training is critical to proper operation of performance models, particularly cognitive systems, and itself constitutes a technical field. The present invention thus represents a significant improvement to the technical field of cognitive system training.

In some embodiments, one or more aspects of the present invention may be carried out using cloud computing. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include various characteristics, service models, and deployment models.

Characteristics can include, without limitation, on-demand service, broad network access, resource pooling, rapid elasticity, and measured service. On-demand self-service refers to the ability of a cloud consumer to unilaterally provision computing capabilities, such as server time and network storage, as needed automatically without requiring human interaction with the service's provider. Broad network access refers to capabilities available over a network and accessed through standard mechanisms that promote use by heterogeneous thin or thick client platforms (e.g., mobile phones, laptops, and personal digital assistants, etc.). Resource pooling occurs when the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity means that capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service is the ability of a cloud system to automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models can include, without limitation, software as a service, platform as a service, and infrastructure as a service. Software as a service (SaaS) refers to the capability provided to the consumer to use the provider's applications running on a cloud infrastructure. The applications are accessible from various client devices through a thin client interface such as a web browser. The consumer does not manage or control the underlying cloud infrastructure including network, servers, operating systems, storage, or even individual application capabilities, with the possible exception of limited user-specific application configuration settings. Platform as a service (PaaS) refers to the capability provided to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a service (IaaS) refers to the capability provided to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models can include, without limitation, private cloud, community cloud, public cloud, and hybrid cloud. Private cloud refers to the cloud infrastructure being operated solely for an organization. It may be managed by the organization or a third party and may exist on-premises or off-premises. A community cloud has a cloud infrastructure that is shared by several organizations and supports a specific community that has shared concerns (e.g., mission, security requirements, policy, and compliance considerations). It may be managed by the organizations or a third party and may exist on-premises or off-premises. In a public cloud, the cloud infrastructure is made available to the general public or a large industry group and is owned by an organization selling cloud services. The cloud infrastructure for a hybrid cloud is a composition of two or more clouds (private, community, or public) that remain unique entities but are bound together by standardized or proprietary technology that enables data and application portability (e.g., cloud bursting for load-balancing between clouds).

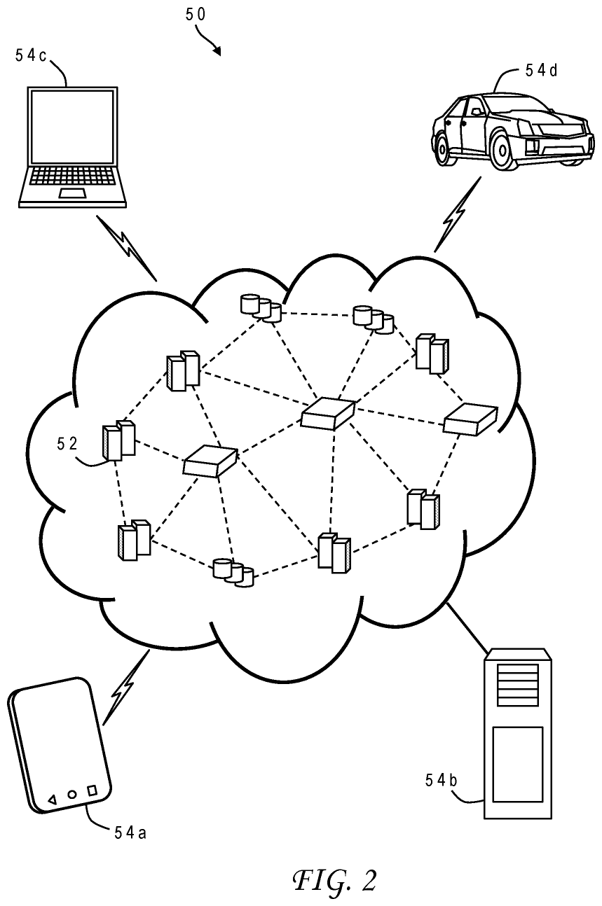

A cloud computing environment is service oriented with a focus on statelessness, low coupling, modularity, and semantic interoperability. At the heart of cloud computing is an infrastructure that includes a network of interconnected nodes. An illustrative cloud computing environment 50 is depicted in FIG. 2. As shown, cloud computing environment 50 includes one or more cloud computing nodes 52 with which local computing devices used by cloud consumers, such as, for example, personal digital assistant (PDA) or cellular telephone 54a, desktop computer 54b, laptop computer 54c, and/or automobile computer system 54d may communicate. Nodes 52 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54a-54d shown in FIG. 2 are intended to be illustrative only and that computing nodes 52 and cloud computing environment 50 can communicate with any type of computerized device over any type of network and/or network addressable connection (e.g., using a web browser).

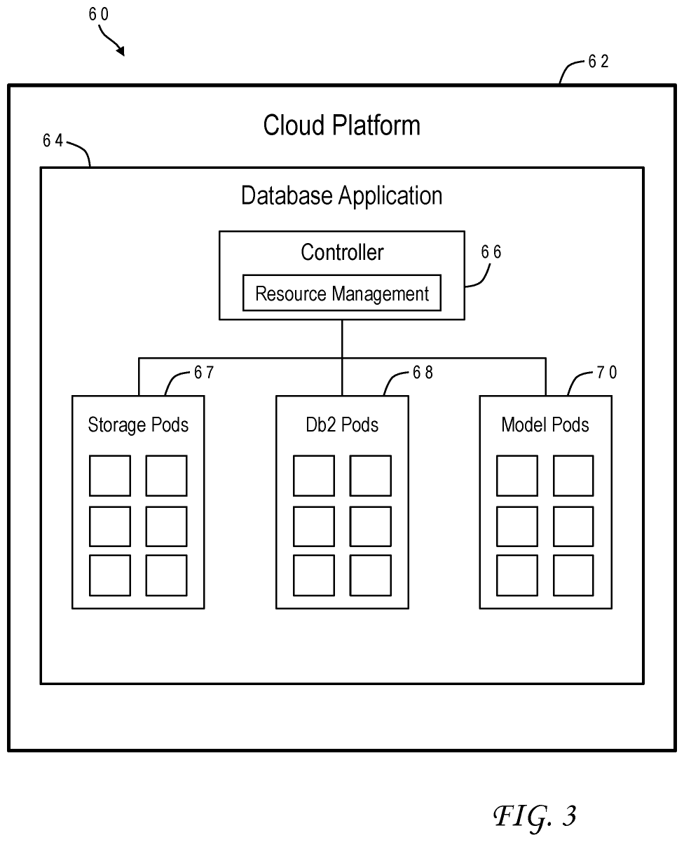

In the illustrative implementation, certain aspects of the present invention can be carried out by a cloud server or cloud computing system. The cloud computing system may for example include a node 52 of FIG. 2 having an architecture like computer system 10 of FIG. 1 or other architectures, in communication with clients via the Internet. The cloud computing system may host any number and type of applications. FIG. 3 illustrates a cloud computing system 60 in accordance with one implementation of the present invention which is deployed on a cloud platform 62 such as the IBM Cloud™ platform. The IBM Cloud™ platform is a suite of cloud computing services from International Business Machines Corp. (IBM) that offers both platform as a service (PaaS) and infrastructure as a service (IaaS). Further to this example, cloud platform 62 hosts a database application such as a Db2 database. Db2 is a family of data management products, including database servers, developed by IBM. It was initially designed as a relational database management system but was extended to support object-relational features and non-relational structures like JSON and XML file formats.

In this implementation database application 64 is embodied in a Kubernetes-type computing infrastructure such as the IBM Cloud™ Kubernetes Service. This service is a managed offering built for creating a Kubernetes cluster of compute hosts to deploy and manage containerized apps on the IBM Cloud™. Kubernetes defines a set of building blocks (primitives), which collectively provide mechanisms that deploy, maintain, and scale applications based on CPU, memory, or custom metrics. The service includes a master or controller 66 and a plurality of pods. Pods are the smallest deployable units of computing or scheduling that can be created and managed in Kubernetes. A pod is a group of one or more containers, with shared storage and network resources, and a specification for how to run the containers. A pod's contents are always co-located and co-scheduled, and run in a shared context. For the Db2 application, pods may include storage pods 67, Db2 pods 68, and model pods 70. Storage pods 67 house the actual operand data that is the subject of the particular database. Db2 pods 68 handle the database operations. Model pods 70 contain the performance models used to detect anomalies in the operations of the Db2 database. There may be other pods not shown. Controller 66 carries out resource management for the cluster such as increasing the number of pods as needed or deleting a pod when it is no longer being used, as well as selecting pods for model training and scoring as discussed further below. Controller 66 can also provide a metric collection service that measures resource utilization for different pods or containers, such as CPU, memory and I/O usage.

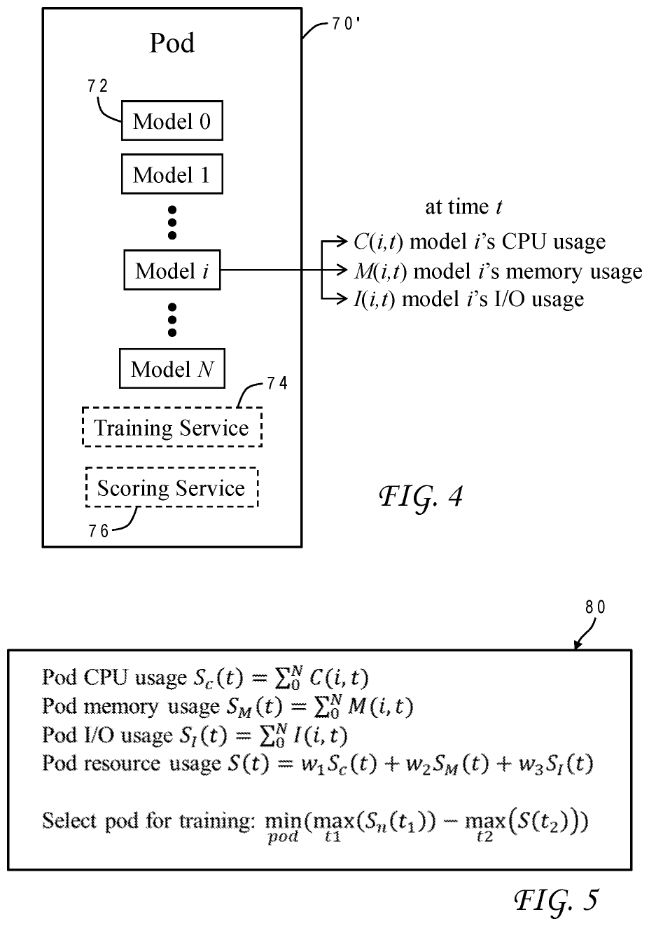

Model training can be understood with further reference to FIG. 4 which shows a model pod 70′ in accordance with the exemplary implementation. Model pod 70′ has a plurality of models 72 therein (0 through N). This particular group of models are all of the same model type. A given model pod can be dedicated to only one group or can handle multiple model groups. Some models in a group are allocated in different pods to balance resource utilization, and FIG. 4 is representational of each of those pods.

A training service 74 is used to train the various models 72. Although training service 74 could be located in a different pod, it is advantageously located in the same pod whose models are being trained. There can be multiple training services for different pods or groups. Training service 74 carries out a training process that first conducts initial, limited training for all of the models 72 on different pods 70′, using conventional training techniques. The initial training is limited in that it involves substantially fewer training data sets than required for reliable training. After this initial training, a single pod 70′ is selected to complete the training as described further below in conjunction with FIG. 5. Once the optimum pod for training is selected, a given model in that pod undergoes complete training. This finished training is then applied to all models of that type, greatly simplifying the task of training large numbers of models. The finished training may be applied in various ways according to the nature of the particular model involved. For example, in a model using a neural network infrastructure, the finished training is embodied in the sets of weights and biases for the neural nodes, and these parameters can be easily copied from the trained model and programmed into the other models.

In the preferred embodiment, the pod used for training is selected by considering resource usage over time. As shown in FIG. 4, for a given model i at time t, the model's CPU usage is denoted as C(i,t), the model's memory usage is denoted as M(i,t), and the model's I/O usage is denoted as I(i,t). Pod metrics 80 can then be computed as seen in FIG. 5. CPU usage S_{C}(t) for a given pod is computed as Σ₀^{N} C(i,t), memory usage S_{M}(t) for a given pod is computed as Σ₀^{N} M(i,t), and I/O usage S_{I}(t) for a given pod is computed as Σ₀^{N}I (i,t). The summary of resource usage for a given pod can then be expressed as:

S(t)=w₁S_{C}(t)+w₂S_{M}(t)+w₃S_{I}(t),

where w₁, w₂, and w₃ are weights set by designer preference. The weights w₁, w₂, and w₃ are generally determined by the model types as well as any limitations on resources. For example, if most of the models need lot of memory, w₂ will be relatively large, and if a system lacks CPU power, w₁ will be relatively large. The pod selected for training is that one whose change in maximum resource usage over a first period of time before new training started compared to a second period of time after new training started is a minimum among all pods, i.e.:

min_{pod}(maxₜ₁(Sₙ(t₁))−maxₜ₂(S(t₂))), (1)

where maxₜ₁(Sₙ(t₁)) means the maximum value at time t₁ if training has started and maxₜ₂(S(t₂)) means the maximum value at time t₂ if training has not started. Formula (1) is further subject to the constraint that S_{C}(t), S_{M}(t) and S_{I}(t) must all be less than a maximum respective value according to the availability of the resource.

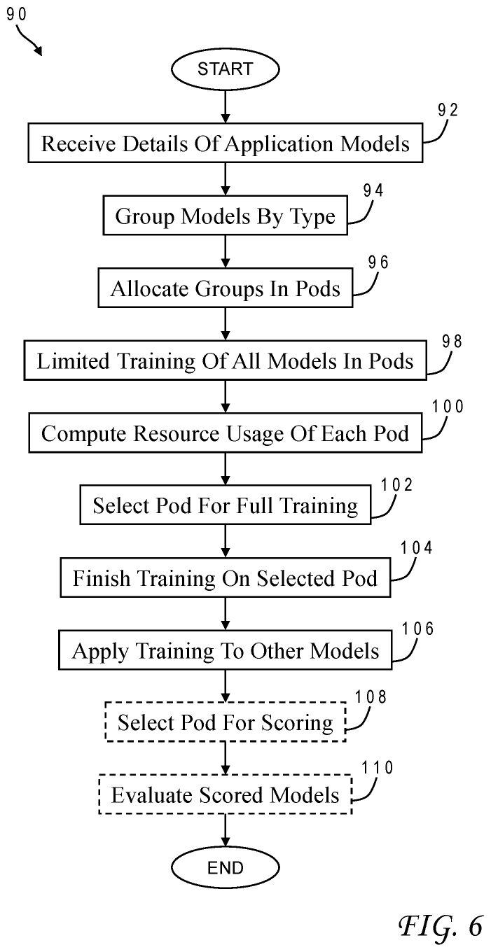

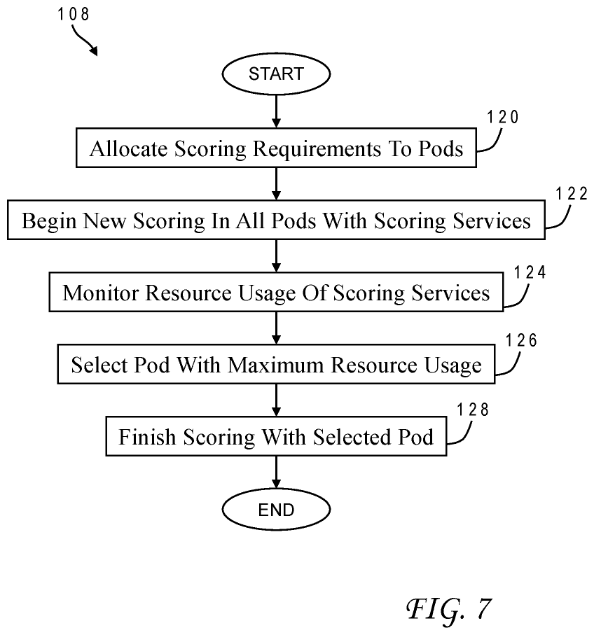

The training of the present invention may be further understood with reference to the chart of FIG. 6 which shows a computer-implemented training process 90 in accordance with one implementation. Process 90 begins by receiving 92 the details regarding the models to be used in detecting anomalies arising from operations of the particular application involved. These details include the number and types of models, and metrics used for each model. Models are then grouped 94 according to type, and the groups are allocated 96 among different pods to balance resource utilization. Limited training of all models in the pods is carried out 98. Resource usages for the pods are computed 100, and a pod is selected for further training 102 according to formula (1) above. Full training is then completed 104 for models in this selected pod, and this training is applied 106 to other models.

Once training is finished, it is necessary to score the models in order to evaluate their accuracy. Training process 90 can thus continue with the selection 108 of a single pod for scoring purposes, in order to again optimize computational efficiency in scoring what would otherwise be a very large number of performance models. This selection process is described further below in conjunction with FIG. 7. After scoring, models can be evaluated 110 to judge their accuracy, and process 90 ends. If models score poorly, more training can be instituted.

In the exemplary implementation, a particular one of the pods is again selected to optimize the process, but this time for scoring rather than training. In other words, the optimum pod for scoring may be different than the optimum pod for training. As seen in FIG. 4, a pod 70′ may in some implementations have a scoring service 76. Scoring service 76 may alternatively be in a different pod so the number of pods can be reduced after training. FIG. 7 shows the scoring pod selection process 108 carried out by scoring service 76. Scoring process 108 starts by allocating 120 the scoring requirements for the pods to balance resource utilization. Initial scoring then begins 122 in all pods. As scoring progresses, resource usage of the scoring services is monitored 124. The pod with the maximum resource usage is selected for continued scoring 126, as this pod is deemed the most extensive scoring of all of the scoring services. Scoring of the trained model can then be finished 128 with the selected pod. The present invention thus provides a superior approach for the training and scoring of very large numbers of performance models, in a manner that regulates system resources in an optimum manner.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A computer-implemented method of training a monitoring system for detection of anomalies in computing operations comprising:
receiving details regarding a plurality of performance models to be used in detecting the anomalies including a number of the performance models, types of the performance models, and metrics used for each of the performance models;
forming a group of the performance models wherein the group is a subset of the performance models that contains fewer than a total number of the performance models;
selecting a particular one of the performance models in the group;
training the particular performance model; and
applying said training to remaining performance models in the group.

2. The computer-implemented method of claim 1 wherein the performance models in the group are trained using machine learning.

3. The computer-implemented method of claim 1 wherein each of the performance models in the group has the same model type.

4. The computer-implemented method of claim 1 wherein:
at least some of the performance models in the group are embodied in respective computing containers in a particular one of a plurality of computing pods which provide shared storage, shared network resources and a shared context for all containers within a given computing pod;
said selecting includes selecting the particular computing pod for said training; and
the particular computing pod contains a training service that carries out said training.

5. The computer-implemented method of claim 4 wherein said selecting of the particular computing pod includes determining that the particular computing pod has a minimum change in resource usage over a first period of time before initial training compared to a second period of time after initial training among all computing pods containing performance models in the group.

6. The computer-implemented method of claim 4 further comprising:
beginning initial scoring of trained performance models in certain computing pods;
monitoring resource usages of the certain computing pods during the initial scoring;
selecting a specific computing pod other than the particular computing pod for continued scoring based on the resource usages; and
completing scoring of at least one performance model using a scoring service contained in the specific computing pod.

7. The computer-implemented method of claim 1 wherein said selecting of the specific computing pod includes determining that the specific computing pod has a maximum resource usage during the initial scoring among all computing pods carrying out the initial scoring.

8. A computer system comprising:
one or more processors which process program instructions;
a memory device connected to said one or more processors; and
program instructions residing in said memory device for training a monitoring system for detection of anomalies in computing operations by receiving details regarding a plurality of performance models to be used in detecting the anomalies including a number of the performance models, types of the performance models, and metrics used for each of the performance models, forming a group of the performance models wherein the group is a subset of the performance models that contains fewer than a total number of the performance models, selecting a particular one of the performance models in the group, training the particular performance model, and applying said training to remaining performance models in the group.

9. The computer system of claim 8 wherein the performance models in the group are trained using machine learning.

10. The computer system of claim 8 wherein each of the performance models in the group has the same model type.

11. The computer system of claim 8 wherein:
at least some of the performance models in the group are embodied in respective computing containers in a particular one of a plurality of computing pods which provide shared storage, shared network resources and a shared context for all containers within a given computing pod;
the selecting of the particular performance model includes selecting the particular computing pod for said training; and
the particular computing pod contains a training service that carries out said training.

12. The computer system of claim 11 wherein the selecting of the particular computing pod includes determining that the particular computing pod has a minimum change in resource usage over a first period of time before initial training compared to a second period of time after initial training among all computing pods containing performance models in the group.

13. The computer system of claim 11 wherein said program instructions further begin initial scoring of trained performance models in certain computing pods, monitor resource usages of the certain computing pods during the initial scoring, select a specific computing pod other than the particular computing pod for continued scoring based on the resource usages, and complete scoring of at least one performance model using a scoring service contained in the specific computing pod.

14. The computer system of claim 8 wherein the selecting of the specific computing pod includes determining that the specific computing pod has a maximum resource usage during the initial scoring among all computing pods carrying out the initial scoring.

15. A computer program product comprising:
one or more computer readable storage media; and
program instructions collectively residing in said one or more computer readable storage media for training a monitoring system for detection of anomalies in computing operations by receiving details regarding a plurality of performance models to be used in detecting the anomalies including a number of the performance models, types of the performance models, and metrics used for each of the performance models, forming a group of the performance models wherein the group is a subset of the performance models that contains fewer than a total number of the performance models, selecting a particular one of the performance models in the group, training the particular performance model, and applying said training to remaining performance models in the group.

16. The computer program product of claim 15 wherein the performance models in the group are trained using machine learning.

17. The computer program product of claim 15 wherein each of the performance models in the group has the same model type.

18. The computer program product of claim 15 wherein
at least some of the performance models in the group are embodied in respective computing containers in a particular one of a plurality of computing pods which provide shared storage, shared network resources and a shared context for all containers within a given computing pod;
the selecting of the particular performance model includes selecting the particular computing pod for said training; and
the particular computing pod contains a training service that carries out said training.

19. The computer program product of claim 18 wherein the selecting of the particular computing pod includes determining that the particular computing pod has a minimum change in resource usage over a first period of time before initial training compared to a second period of time after initial training among all computing pods containing performance models in the group.

20. The computer program product of claim 18 wherein said program instructions further begin initial scoring of trained performance models in certain computing pods, monitor resource usages of the certain computing pods during the initial scoring, select a specific computing pod other than the particular computing pod for continued scoring based on the resource usages, and complete scoring of at least one performance model using a scoring service contained in the specific computing pod.
